(19) United States
(12) Patent Application Publication
(10) Pub. No.: US 2019/0047267 A1
(43) Pub. Date: Feb. 14, 2019

(54) PACKAGING TRAY WITH SURFACE-TREATED CAPPING LAYER

(71) Applicant: Bemis Company, Inc., Neenah, WI (US)

(72) Inventors: JianCheng LIU, Neenah, WI (US); Chunjuan SHENG, Neenah, WI (US)

(21) Appl. No.: 16/077,665

(22) PCT Filed: Feb. 15, 2016
(86) PCT No.: PCT/US2016/017933

§ 371 Date: Aug. 13, 2018

(51) Int. Cl. B32B 27/08; B32B 27/36; B32B 27/32; B32B 27/30; B65D 1/34; B65D 65/40

(52) U.S. Cl. CPC B32B 27/08; B32B 27/36; B32B 27/32; B32B 27/308; B32B 2307/7244; B65D 1/34; B65D 65/40; B32B 2439/02; B32B 27/306

(57) ABSTRACT

The present invention is directed to rigid or semi-rigid trays having a bulk layer comprising a crystalline aromatic polyester and a capping layer which is in direct contact with the bulk layer. The capping layer comprises a polyethylene-based polymer and is surface-treated to increase its surface tension. It has been discovered that the bulk layer and the capping layer of the present invention can be readily laminated together and have sufficient bond strength to each other despite their chemical dissimilarity. In some preferred embodiments, the capping layer acts as a heat seal layer and is formulated to heat seal to conventional polyolefin-based lidstock.

### BACKGROUND OF THE INVENTION

The present invention relates generally to primary packaging and more particularly, to plastic trays. More specifically, this invention relates to polyester trays which will heat seal to lidding films having a polyolefin-based sealant layer.

Polyesters such as polyethylene terephthalate (PET) are engineering thermoplastics used in a wide variety of end use applications such as fibers, films, automotive parts, food and beverage containers and the like. PET can be processed by a variety of techniques including injection molding, compression molding, extrusion, thermoforming, blow molding, and combinations thereof. Extruded into films or sheets of between 100 and 1000 microns thick, PET may be used as-fabricated or shaped, e.g., by thermoforming, into rigid or semi-rigid packaging articles such as trays for containing food products. For example, extruded PET sheet can be thermoformed to make trays, packages or containers in which, refrigerated or frozen foods can be both stored and heated and/or cooked in an oven. Such materials are recyclable where the infrastructure is available and certain applications will also be able to incorporate post-consumer recycled content. Food trays fabricated from crystallized PET (CPET) sheet retain good dimensional stability over the range of temperatures commonly encountered during both microwave and conventional oven cooking. When such packages are produced, the food product is placed in a rigid tray, whereupon a flexible plastic lidding film is heat-sealed to the tray by a perimeter heat seal on the flange of the tray to finish the package. The lidding film or lidstock may form a hermetic heat seal to the tray. It is important that there is sufficient adhesion between the lidstock and tray during the packaging process, package shipment and handling, and under cooking and/or pasteurization/sterilization conditions in order to maintain a hermetic heat seal which protects the product from environmental contamination and spoilage. Those skilled in the art have long-recognized that weak seals are often produced when heat sealing two chemically dissimilar materials directly together. It is typical for the outer surface layer or sealant layer of the lidstock to include a resin material which is chemically similar to the material used for the outer surface layer or capping layer of the tray in order to achieve sufficient adhesion between these packaging components. Often, the sealant layer of the lidstock to be sealed to a PET tray comprises co-polyesters such as amorphous polyethylene terephthalate (APET) or blends thereof. However, because the bonds between these materials and PET tend to be very strong, the package is difficult to open without the use of knife or other cutting implement. Furthermore, the temperature range for heat sealing these materials together is relatively narrow and generally they do not readily seal through food contamination in the seal area compared to conventional polyolefin-based heat sealing materials.

### SUMMARY OF THE INVENTION

The present invention is directed to rigid or semi-rigid trays having a bulk layer comprising a crystalline aromatic polyester and a capping layer which is in direct contact with the bulk layer. The capping layer comprises a polyethylene-based polymer. Surprisingly, it has been discovered that when the capping layer is surface-treated to exhibit a surface tension of at least 36 dynes/cm, the bulk and capping layers can be readily laminated together and have sufficient bond strength to each other despite their chemical dissimilarity. The bulk and capping layers of the present invention are also capable of being thermoformed in a mould after being laminated together to give a thermoformed article of acceptable properties. Advantageously, a polyethylene-based capping layer on the tray of the present invention permits the use of conventional polyolefin-based materials in the sealant layer of lidstocks. By selective formulation of the capping layer composition and surface treatment to change its surface energy, the film interface between the bulk and capping layers can be readily adjusted to produce both peelable and non-peelable packaging containers.

Another important aspect of the present invention is that the capping layer may be formulated and its film surface subsequently treated to control the seal strength between it and the bulk layer. In some preferred embodiments, the seal strength between the capping layer and the bulk layer may vary between 161 g/cm and 739 g/cm (410 g/in and 1878 g/in). This is also advantageous because the seal strength between these layers may be regulated to permit manual peelable opening of the package, yet be sufficiently high enough to prevent failure of the seal during normal handling and storage. “Manually peelable” and like terminology is used herein to refer to film interface between two adjoining layers which are engineered to be readily peelable without uncontrolled or random tearing or rupturing the packaging materials which may result in premature destruction of the package and/or inadvertent contamination or spillage of the contents of the package. A manually peelable interface is one that can be manually peeled and/or fractured apart to open the package at the seal without resort to a knife or other implement to open the package. In general, a manually peelable film interface has a bond strength of less than 787.4 g/cm (2000 g/in).

In some preferred embodiments, the capping layer is on the inside of the tray where it comes into contact with the contents of the tray. In such embodiments, the capping layer acts as a heat seal layer and is formulated to heat seal to conventional polyolefin-based lidstock. In some preferred embodiments, the seal strength between the capping layer of the tray and lidstock may be controlled to provide a relatively strong heat seal between the tray and lidstock. This is advantageous because it permits the use of conventional lidding films which have a broad temperature range for heat sealing and generally readily seal through food contamination in the seal area. This is further advantageous because it allows for the use of conventional peelable lidding films having an internal frangible layer or interface and thus, a means to manually peel open a package. Manually peelable lidding films are known in the art and have been described in U.S. RE 37,171 (Busche et al.), U.S. Pat. No. 7,927,679 (Cruz et al.), U.S. Pat. No. 8,283,010 (Cruz et al.), U.S. Pat. No. 8,283,011 (Cruz et al.), and U.S. Pat. No. 8,329,276 (Cruz).

In some preferred embodiments, the capping layer may be part of a multilayer film where a different layer acts as a heat seal layer and is in contact with the contents of the tray. In such embodiments, the bulk layer and the multilayer film may be readily laminated together.

The trays of the present invention may advantageously be used to hold oxygen or moisture sensitive food products and non-food articles. To this end, the capping layer may be part of a multilayer film which includes at least one oxygen and/or moisture barrier layers. The terms “barrier” or “barrier layer” as used herein means a layer which acts as a physical barrier to moisture and/or oxygen molecules. Oxygen barrier materials which may include, but are not limited to, ethylene vinyl alcohol copolymers (EVOH), polyacrylonitriles, polyamides (nylons), vinylidene chloride copolymers (PVDC) crystalline polyethylene terephthalate polymer (CPET). For some applications, the oxygen barrier material may also include metal foils, such as aluminum foil and barrier coatings deposited onto a polymer layer such as silica, alumina and the like. The tray having an oxygen barrier layer may exhibit an oxygen transmission rate of less than about 1.0 cm³/100 in²/24 hours (h) at 73° F., 0% relative humidity (RH) and 1 atmosphere (atm) (or about 15.5 cm³/m²/24 h at 23° C., 0% RH and 1 atm), preferably, less than about 0.5 cm³/100 in²/24 h at 73° F., 0% RH and 1 atm (or about 7.75 cm³/m²/24 h at 23° C., 0% RH and 1 atm), and most preferably, about 0.2 cm³/100 in²/24 h at 73° F., 0% RH and 1 atm (or about 3.1 cm³/m²/24 h at 23° C., 0% RH and 1 atm).

As used throughout this application, the terms “thermoformable” and “thermoformed” refer to monolayer or multilayer thermoplastic polymer sheets, films or webs having sufficient rigidity or stiffness to be formed into a desired shape by the application of a differential pressure between the film or sheet and a mold, by the application of heat, by the combination of heat and the application of a differential pressure between the film or sheet and a mold, or by any thermoforming technique known to those skilled in the art. In one conventional process, the thermoplastic polymers used to form the bulk and capping layers of the present invention may be co-extruded in sheet form and cooled. The sheets may then be subsequently reheated, for example by a hot roll, by a convection oven or by infrared heaters, placed over a mould and formed to the shape of the mould by the application of vacuum to the mould or by the application of pressure to the sheet. In an alternative method, the thermoplastic polymers used to form the bulk and capping layers may be co-extruded together and then thermoformed by a process commonly known as a “melt-to-mold” process. The “melt-to-mold” process is a method of manufacturing crystallizable polyester-containing articles which controls the cooling rate of the molten material and hence, the amount of crystallization present in the polyester. A number of prior patents describe the “melt-to-mold” method with which one of ordinary skill in the art may use to co-extrude and form the trays of the present invention; these include U.S. Pat. No. 4,061,706 (Duffield et al.), U.S. Pat. No. 5,106,567 (Demerest) and U.S. Pat. No. 6,077,904 (Dalgewicz III et al.), the disclosures of which are incorporated herein by references in their entireties.

As used throughout this application, the term “aromatic polyester” refers to any polyester having at least one phenyl (or benzene) moiety within one or both monomer repeating units used to form the material. Specific non-limiting examples of aromatic polyesters may include a homopolymer or copolymer of alkyl-aromatic esters including polyethylene terephthalate, polytrimethylene terephthalate, polybutylene terephthalate, polyhexamethylene terephthalate; polyethylene-2,6-naphthalate, polytrimethylene-2,6-naphthalate, polybutylene-2,6-naphthatate, polyhexamethylene-2,6-naphthalate, polyethylene isophthalate, polytrimethylene isophthalate, polybutylene isophthalate, polyhexamethylene isophthalate, poly-1,4-cyclohexane-dimethanol terephthalate, and polybutylene adipate terephthalate and derivatives thereof.

It is within the scope of the present invention that crystallization may be induced in some amorphous aromatic polyesters by thermal crystallization, strain/strain-induced crystallization, nucleating agent crystallization or any combination thereof. Thermally induced crystallization occurs when the polymer is heated above its glass transition temperature, T_{g} and not quenched rapidly enough. In stress/strain-induced crystallization, stretching or orientation is applied to the heated polymer and the polymer chains are rearranged in a parallel fashion and become closely packed. Thermal crystallization and stress/strain-induced crystallization of amorphous aromatic polyester, particularly amorphous polyethylene terephthalate can occur during the melt-to-mold process as described above. As used throughout this application, the term “crystalline aromatic polyester” refers to any polyester having at least 1% by weight, at least 2% by weight, at least 5% by weight, at least 10% by weight, at least 15% by weight, at least 20% by weight, at least 30% by weight, at least 40% by weight, or at least 50% by weight crystallinity. One commonly known method of determining the degree of crystallinity of aromatic polyester is by the use of x-ray diffraction analysis.

As used throughout this application, the term “polyethylene-based polymer” refers to well-known homopolymers, copolymers, including e.g., bipolymers, terpolymers, etc., having a methylene linkage between monomer units which may be formed by any method known to those skill in the art. Suitable examples of polyethylene-based polymers include, but are not limited to, polyethylene, low density polyethylene, linear low density polyethylene, very low density polyethylene, ultra-low density polyethylene, medium density polyethylene, high density polyethylene, ethylene/propylene copolymers, ethylene/vinyl acetate copolymers, ethylene/methyl acrylate copolymers, ethylene/acrylic acid copolymers, ethylene/methacrylic acid copolymers, neutralized salts of ethylene/methacrylic acid copolymer (ionomers), anhydride-modified polyethylenes, copolymers of ethylene with one or more alpha-olefins (α-olefins) such as butene-1, hexene-1, octene-1, and the like.

As used herein, the phrase “surface-treatment” as applied to the capping layer of the present invention refers to any technique which alters the surface energy (or surface tension) of the layer and may include well-known techniques such as, but not limited to, corona and atmospheric plasma treatments, ozone, ultra-high frequency electrical discharge, UV or laser bombardment, chemical priming, and the like. The phrase “corona treatment” (sometimes referred to as air plasma) refers to, in general, a process wherein a low temperature electrical discharge generated by a high-voltage electric field passes through a polymer substrate. It is believed that the electrical discharge or “corona” may ionize the oxygen molecules surrounding the substrate which chemically interact with the surface atoms of the substrate thereby changing the surface energy or surface tension of the polymer substrate. Other technologies useful for surface treatment of the capping layer include in-line atmospheric (air) plasma systems, flame plasma systems, ion beam systems, chemical plasma systems, gamma-ray systems, and electron beam systems.

As used herein, the phrases “surface tension” and “surface energy” are used interchangeably herein and refer to the affinity between molecules at the surface of the capping layer for one another. It is appreciated by a person of ordinary skill in the art that surface tension is a measure of surface energy of a polymer film substrate which involves determination of the interaction between the solid film substrate and a test liquid or “dyne liquid.” Surface tension is expressed in units of force per unit of width, e.g., dynes per centimeter (or dynes/cm). Measuring surface energy of a polymer film substrate may also be known as a “dyne test.” Typically, a dyne test involves applying a dyne liquid, e.g., a predetermined mixture of ethylene glycol monoethyl ether and formamide having a known surface tension, across a one square inch of a polymer surface. If the continuous film of liquid remains intact or fails to wet-out for two or more seconds, the next higher surface tension liquid is applied. If the liquid dissipates in less than two seconds, the next lower surface tension solutions are tried until an exact measurement is attained. The dyne test is based on ASTM D-2578-84 Test Method, which is incorporated herein by reference in its entirety. The surface tension of a polymer may be altered by any conventional surface-treatment known in the art and those described herein. Typically, untreated polyethylene-based polymers have relatively low surface tension of between about 30-32 dyne/cm. In contrast, untreated polyethylene terephthalate has a relatively high surface tension of 43 dyne/cm.

As used herein, terminology employing a “/” with respect to the chemical identity of any copolymer, e.g., “ethylene/vinyl acetate copolymer”, in general identifies the comonomers which are copolymerized to product the copolymer.

### BRIEF DESCRIPTION OF THE DRAWINGS

Further features and advantages of the present invention will become apparent from the following detailed description, taken in combination with the appended drawings, in which:

FIG. 1 illustrates a schematic of one embodiment of a tray according to the present invention.

FIG. 2 illustrates a schematic cross-sectional view of one embodiment of a tray according to the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

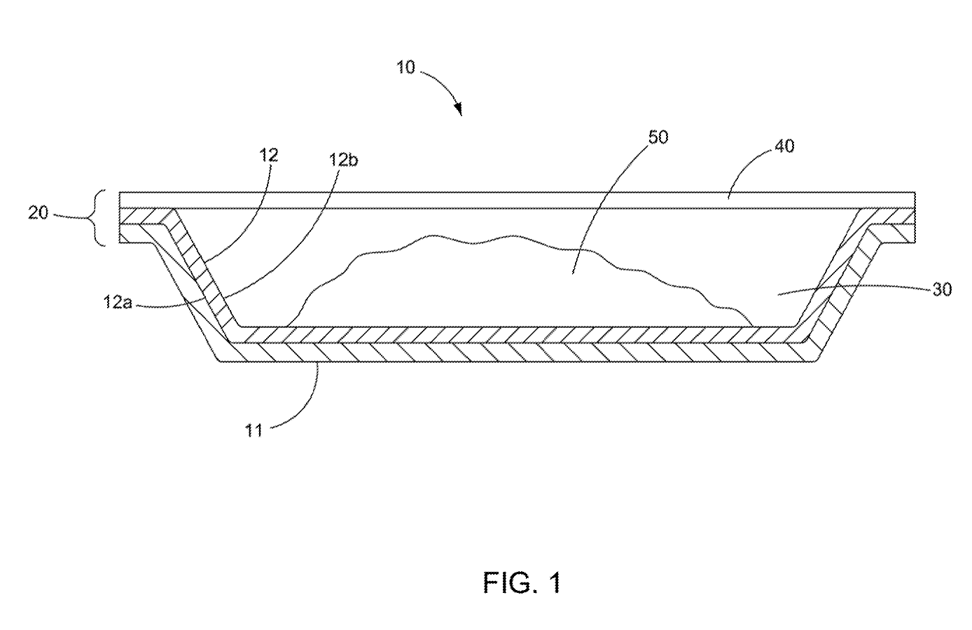

One preferred embodiment of tray 10 of the present invention is illustrated in FIG. 1. It should be understood that tray 10 may be of any shape desired, such as, for example, rectangular, square, and circular or polygon depending on both functional and aesthetic requirements. It will be appreciated that tray 10 is thermoformed to any depth as desired depending upon type and amount of food or non-food product to be packaged. It should also be appreciated that tray 10 may be configured to include two or more recessed areas (not shown) depending again on both functional and aesthetic requirements of a particular packaging application. In some preferred embodiments, tray 10 includes a sealing flange 20 extending around the periphery of a recessed cavity 30 to facilitate the sealing of a lidding film 40 to enclose a food product 50 as is shown in FIG. 1.

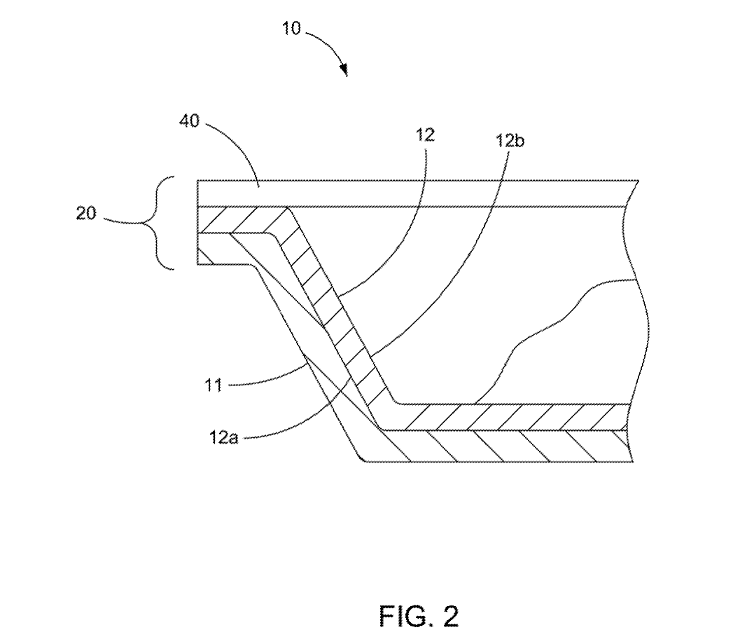

Referring now more particularly to FIG. 2 of the drawings, a preferred embodiment of tray 10 embodying the present invention is shown. Tray 10 includes a bulk layer 11 comprising a crystalline aromatic polyester and a capping capping layer 12 which is in direct contact with bulk layer 11. The capping layer 12 has a first surface 12a and a second surface 12b. It is the first surface 12a of capping layer 12 which is in direct contact with bulk layer 11.

In some preferred embodiments, bulk layer 11 comprises a crystalline aromatic polyester. Such crystalline aromatic polyester may include, but are not limited to, polyethylene terephthalate, polytrimethylene terephthalate, polybutylene terephthalate, polyhexamethylene terephthalate; polyethylene-2,6-naphthalate, polytrimethylene-2,6-naphthalate, polybutylene-2,6-naphthalate, polyhexamethylene-2,6-naphthalate, polyethylene isophthalate, polytrimethylene isophthalate, polybutylene isophthalate, polyhexamethylene isophthalate, poly-1,4-cyclohexane-dimethanol terephthalate, and polybutylene adipate terephthalate and derivatives thereof. In one preferred embodiment, bulk layer 11 comprises crystalline polyethylene terephthalate. It is also contemplated that additives such as, but not limited to, anti-oxidants, anti-static and anti-block agents, impact modifiers, nucleating agents, recycled PET, inorganic fillers, and other polymeric materials may be included in the bulk layer at concentrations typically known in the art to improve the extrusion process and layer properties of the final tray. In the various embodiments of the invention, it is preferred that the bulk layer 11 makes up between 50% and 99% of the thickness of the tray. In other preferred embodiments, the bulk layer 11 has a thickness of between about 381 micron (15 mil) and about 1270 micron (50 mil). In particularly preferred compositions, bulk layer 11 includes between about 85% and 100% by weight of a crystalline polyethylene terephthalate and between 0% and 15% by weight of an additive mixture of impact modifiers, nucleating agents/or recycled PET. In other particularly preferred compositions, bulk layer 11 may include mixtures described in U.S. Pat. No. 6,077,904, the disclosure of which is incorporated herein by reference in its entirety. For example, bulk layer 11 may include between about 60% and 99% by weight of a crystalline polyethylene terephthalate which functions as the base polymer, between about 1% and 15% by weight of additive mixture including an impact modifier from the group consisting of polymers of ethylene-methyl acrylate, ethylene-butyl acrylate, ethylene-ethyl acrylate, ethylene-vinyl acetate, ethylene-maleic acid, polypropylene, polybutadiene, polymethyl methacrylate-polycarbonate shell core modifier and paramethylstyrene, a compatibilizer which functions to improve the surface properties between the polyethylene terephthalate and the impact modifier and a nucleating agent, and between about 0% and 40% by weight of recycled PET.

The capping layer 12 includes a polyethylene-based polymer such as polyethylene, low density polyethylene, linear low density polyethylene, very low density polyethylene, ultra-low density polyethylene, medium density polyethylene, high density polyethylene, ethylene/propylene copolymers, ethylene/vinyl acetate copolymer, or a copolymer of ethylene with one or more alpha-olefins (α-olefins). In some preferred embodiments, the capping layer 12 is a monolayer film. In other preferred embodiments, capping layer 12 is a multilayer film. In such embodiments, the multilayer film of the capping layer includes at least one barrier layer such as an oxygen barrier layer. These multilayer films may include any number of layers including, but not limited to oxygen barrier layers, tie layers, abuse layers, chemical barrier layers and the like.

### WORKING EXAMPLES

In the following Examples 1-3 and Comparative Examples 1-2, there is described various embodiments of a tray 10 having a two-layer structure as illustrated in FIGS. 1-2. In all these examples, the first surface 12a of the capping layer 12 was surface-treated by corona and/or plasma techniques known in the art using a watt density of 1.5. The plasma treatment used a gas mixture of 85.5% nitrogen, 10% oxygen and 4.5% hydrogen. After treatment, the bulk layer 11 and capping layer 12 were extrusion laminated into a sheet form by feeding the capping layer under a nip roll with the bulk layer extrudate which was extruded using a single-screw extruder at 260° C. (500° F.). In all these examples, the thickness of the bulk layer 11 was about 760 micron (30 mil) and the thickness of the capping layer 12 was about 76 micron (3 mil).

### Example 1

Example 1 is one preferred embodiment of tray 10 of the present invention having a structure and layer compositions as described below. Reported below is the layer composition relative to the total weight of the layer.

Layer 11: 100 wt.-% of a crystalline polyethylene terephthalate homopolymer (CPET) having an intrinsic viscosity (IV) of 0.89 dl/g and a melting point of 254° C-TRAYTUF® 8906 (M&G Polymers USA, LLC, Houston, Tex. USA).

Layer 12: 100 wt.-% of a low density polyethylene having a density of 0.923 g/cm³ and a melt index of 3.7 g/10 min-LyondellBasell Petrothene® NA216000 (LyondellBasell, Houston, Tex., USA).

### Example 2

Example 2 is another preferred embodiment of tray 10 of the present invention having a structure and layer compositions as described below. Reported below is the layer composition relative to the total weight of the layer.

Layer 11: 100 wt.-% of a crystalline polyethylene terephthalate homopolymer (CPET) having an intrinsic viscosity (IV) of 0.89 dl/g and a melting point of 254° C-TRAYTUF® 8906 (M&G Polymers USA, LLC, Houston, Tex. USA).

Layer 12: 100 wt.-% of an ethylene/vinyl acetate copolymer having a vinyl acetate content of 2.5 wt.-%, a density of 0.926 g/cm³ and a melt index of 2.5 g/10 min-LyondellBasell Petrothene® NA420000 (LyondellBasell, Houston, Tex., USA).

### Example 3

Example 3 is another preferred embodiment of tray 10 of the present invention having a structure and layer compositions as described below. Reported below is the layer composition relative to the total weight of the layer.

Layer 11: 100 wt.-% of a crystalline polyethylene terephthalate homopolymer (CPET) having an intrinsic viscosity (IV) of 0.89 dl/g and a melting point of 254° C-TRAYTUF® 8906 (M&G Polymers USA, LLC, Houston, Tex. USA).

Layer 12: 100 wt.-% of an ethylene/vinyl acetate copolymer having a vinyl acetate content of 10 wt.-%, a density of 0.93 g/cm³ and a melt index of 0.35 g/10 min-DuPont™ Elvax® 3129-1 (E.I. du Pont de Nemours and Company, Wilmington, Del., USA).

### Comparative Example 1

Comparative Example 1 is an embodiment of a tray having a structure and layer compositions as described below. Reported below is the layer composition relative to the total weight of the layer.

Layer 11: 100 wt.-% of a crystalline polyethylene terephthalate homopolymer (CPET) having an intrinsic viscosity (IV) of 0.89 dl/g and a melting point of 254° C-TRAYTUF® 8906 (M&G Polymers USA, LLC, Houston, Tex. USA).

Layer 12: 100 wt.-% of a polypropylene homopolymer having a nelting point of 163° C., a density of 0.905 g/cm³, and a melt index of 9 g/10 min-Fina 3576X (Total Petrochemicals USA, Inc., Houston, Tex., USA).

### Comparative Example 2

Comparative Example 2 is an embodiment of a tray having a structure and layer compositions as described below. Reported below is the layer composition relative to the total weight of the layer.

Layer 11: 100 wt.-% of a crystalline polyethylene terephthalate homopolymer (CPET) having an intrinsic viscosity (IV) of 0.89 dl/g and a melting point of 254° C-TRAYTUF® 8906 (M&G Polymers USA, LLC, Houston, Tex. USA).

Layer 12: 100 wt.-% of a sodium neutralized ionomer having a density of 0.94 g/cm³, a melting point of 98° C., and a melting index of 1.3 g/10 min-DuPont™ Surlyn® 1601-2 (E.I. du Pont de Nemours and Company, Wilmington, Del., USA).

### BOND STRENGTH BETWEEN BULK AND CAPPING LAYERS

Specimens for testing bond strength between the bulk layer and the capping layer of each of the above examples were prepared by first heat sealing each example to a two-layer support substrate of 75-gauge OPET/3-mil EVA with capping layer (layer 12) of each example being heat sealed to the EVA layer of the support substrate. The heat sealing parameters were 300° F. (149° C.) under a pressure of 40 psi for a dwell time of 1 second. Next, the specimens were cut to roughly 1-inch wide by 4-inch long pieces and an end section of the bulk layer and capping layer with the two-layer support substrate were secured to an Instron® Pull Tester Model No. 5967 (Norwood, Mass. USA). Each specimen was pulled apart at a 180° angle at a rate of 12 in/min while the average force (gram/inch) to separate the bulk layer from the capping layer of the specimen was measured at room temperature (23° C.) in accordance with ASTM Test Method F-904. The results are reported in TABLE 1 below.

TABLE 1
Bond Strength Between Bulk and Capping Layers

| | Surface Tension | | Average Bond Strength | | |
|---|---|---|---|---|---|
| | (dyne/cm) | | (g/cm) | | |
| | Corona- | Plasma- | Not | Corona- | Plasma- |
| Sample | treated | treated | Treated | treated | treated |
| Example 1 | 42 | 40 | 11.1 | 161.6 | 194.9 |
| Example 2 | 46 | 42 | 33.9 | 508.7 | 303.7 |
| Example 3 | 40 | 52 | 118.1 | 739.4 | 633.4 |
| Comparative | — | 38 | — | — | 19.7 |
| Example 1 | | | | | |
| Comparative | — | 52 | — | — | 29.5 |
| Example 2 | | | | | |

It should be evident to one of ordinary skill in the art that based on the above results the bond strength between a bulk layer of crystalline PET and a capping layer comprising a polyethylene-based polymer having been surface-treated may be controlled to provide a bond strength value therebetween within a range of between 161.6 g/cm and 739.4 g/cm and thus, readily adjusted to meet the needs of a particular application by selective formulation of the capping layer composition and selective surface treatment.

The above description and examples illustrate certain embodiments of the present invention and are not to be interpreted as limiting. Selection of particular embodiments, combinations thereof, modifications, and adaptations of the various embodiments, conditions and parameters normally encountered in the art will be apparent to those skilled in the art and are deemed to be within the spirit and scope of the present invention.

What is claimed is:

1. A tray comprising:
a bulk layer comprising a crystalline aromatic polyester;
a capping layer having a first surface and a second surface, wherein the first surface is bonded to and in direct contact with the bulk layer and the capping layer comprises a polyethylene-based polymer; and
wherein the bond between the bulk layer and the capping layer has a bond strength of at least about 161.6 g/cm (410.5 g/in) but less than about 787.4 g/cm (2000 g/in), whereby the capping layer is manually peelable from the bulk layer.

2. The tray according to claim 1, wherein the crystalline aromatic polyester is selected from the group consisting of polyethylene terephthalate, polytrimethylene terephthalate, polybutylene terephthalate, polyhexamethylene terephthalate; polyethylene-2,6-naphthalate, polytrimethylene-2,6-naphthalate, polybutylene-2,6-naphthalate, polyhexamethylene-2,6-naphthalate, polyethylene isophthalate, polytrimethylene isophthalate, polybutylene isophthalate, polyhexamethylene isophthalate, poly-1,4-cyclohexane-dimethanol terephthalate, and polybutylene adipate terephthalate and derivatives thereof.

3. The tray according to claim 1, wherein the crystalline aromatic polyester is polyethylene terephthalate.

4. The tray according to claim 1, wherein the polyethylene-based polymer is a low-density polyethylene (LDPE), linear low-density polyethylene (LLDPE), very low-density polyethylene (VLDPE), ultra low-density polyethylene (ULDPE), medium-density polyethylene (MDPE), high-density polyethylene (HDPE), ultra high-density polyethylene (UHDPE), ethylene/α-olefin copolymer (E/AO), ethylene/propylene copolymers, anhydride-modified polyethylenes or blends thereof.

5. The tray according to claim 1, wherein the polyethylene-based polymer is a low density polyethylene.

6. The tray according to claim 1, wherein the polyethylene-based polymer is an ethylene/methyl acrylate copolymer, ethylene/methyl methacrylate copolymer, ethylene/ethyl acrylate copolymer, ethylene/ethyl methacrylate copolymer, ethylene/butyl acrylate copolymer, ethylene/2-ethylhexyl methacrylate copolymer, ethylene/vinyl acetate copolymer, ethylene/acrylic acid copolymers, ethylene/methacrylic acid copolymers, neutralized salts of ethylene/methacrylic acid copolymers (ionomers) or blends thereof.

7. The tray according to claim 1, wherein the polyethylene-based polymer is an ethylene/vinyl acetate copolymer.

8. The tray according to claim 7, wherein the ethylene/vinyl acetate copolymer has a vinyl acetate content of between 2.5% and 10% by weight.

9. (canceled)

10. The tray according to claim 1, wherein the capping layer is a monolayer film.

11. The tray according to claim 1, wherein the capping layer is a multilayer film.

12. The tray according to claim 11, wherein the multilayer film has an oxygen barrier such that the tray exhibits an oxygen transmission rate of less than about 15.5 cm³/m²/24 h at 23° C., 0% RH and 1 atm (1.0 cm³/100 in²/24 h at 73° F., 0% RH and 1 atm).

13. (canceled)

14. (canceled)

15. The tray according to claim 1, wherein the bond between the bulk layer and the capping layer has a bond strength of at least about 194.9 g/cm (495 g/in).

16. The tray according to claim 1, wherein the bond between the bulk layer and the capping layer has a bond strength of at least about 303.7 g/cm (771.5 g/in).

17. The tray according to claim 1, wherein the bond between the bulk layer and the capping layer has a bond strength of at least about 508.7 g/cm (1292 g/in).

18. The tray according to claim 1, wherein the bond between the bulk layer and the capping layer has a bond strength of at least about 633.4 g/cm (1608.8 g/in).

19. The tray according to claim 1, wherein the bond between the bulk layer and the capping layer has a bond strength of at least about 739.4 g/cm (1878 g/in).

20. The tray according to claim 1, wherein the bulk layer is between 50% and 99% of the total thickness of the tray.
